(19) United States
(12) Patent Application Publication
(10) Pub. No.: US 2025/0066133 A1
(43) Pub. Date: Feb. 27, 2025

(54) CONVEYING DEVICE FOR OBJECTS TO BE CONVEYED AND METHOD FOR PRODUCING A CONVEYING DEVICE

(71) Applicant: Bausch + Ströbel SE + Co. KG, Ilshofen (DE)

(72) Inventors: Stefan Blumenstock, Ilshofen (DE); Holger Dierolf, Ilshofen (DE)

(21) Appl. No.: 18/942,944

(22) Filed: Nov. 11, 2024

Related U.S. Application Data
(63) Continuation of application No. PCT/EP2023/061844, filed on May 4, 2023.

(30) Foreign Application Priority Data
May 12, 2022 (DE) 10 2022 111 875.4

(51) Int. Cl. B65G 27/02

(52) U.S. Cl. CPC B65G 27/02; B65G 2201/027

(57) ABSTRACT

A conveying device for objects, such as pharmaceutical packaging material or parts, includes or forms a conveying pot with a base wall, or is part of a conveying pot with a base wall. The device features a jacket that has an inner peripheral surface and an outer peripheral surface and that extends from a first side to a second side. At least one conveying path for the objects runs helically along the inner peripheral surface from the first side to the second side. The at least one conveying path has at least one anchoring element. The jacket includes at least one through-opening assigned to the at least one anchoring element. The at least one anchoring element reaches through or engages in the at least one through-opening and is integrally bonded to an edge of the at least one through-opening during production, in particular by welding.

### CROSS-REFERENCE TO RELATED APPLICATIONS

This application is a continuation application of international application number PCT/EP2023/061844, filed on May 4, 2023, and claims the benefit of German application number 10 2022 111 875.4, filed on May 12, 2022, which are incorporated herein by reference in their entirety and for all purposes.

### FIELD

The present disclosure relates to a conveying device for objects to be conveyed, for example for pharmaceutical packaging material or parts thereof. The packaging materials can, for example, be containers such as vials, syringes, cartridges, or ampules, whereby the objects to be conveyed are closing elements for closing the packaging materials—for example, stoppers or crimp caps. In another type of application, the objects to be conveyed are, for example, packaging materials themselves, such as vials made of plastic or glass. The conveying device comprises at least one helical conveying path for the objects to be conveyed and may, for example, comprise or form a conveying pot with a base wall or be part of a conveying pot with a base wall.

Furthermore, the present disclosure also relates to a method for producing a conveying device.

### BACKGROUND

A conveying device of the type described above is used, for example, in a plant for processing pharmaceutical packaging materials, in particular pharmaceutical containers. For example, the objects to be conveyed are fed to the conveying device, which is set in motion, in particular in oscillation, by means of a drive device. This allows the objects to be conveyed to reach the conveying path, which is usually configured helically and extends from the base wall towards a free edge of the conveying device, where the objects to be conveyed can be released and fed for processing.

A conveying device for objects to be conveyed in the form of stoppers is described in EP 1 593 619 A1.

### SUMMARY

An object underlying the present disclosure is to provide a conveying device for objects to be conveyed which can be produced in a structurally simple manner.

In a first aspect of the present disclosure, a conveying device for objects to be conveyed is provided, the objects being pharmaceutical packaging material or parts thereof, for example. The conveying device optionally comprises or forms a conveying pot with a base wall or is part of a conveying pot with a base wall. The conveying device comprises a jacket which comprises an inner peripheral surface and an outer peripheral surface and extends from a first side to a second side, and at least one conveying path for the objects to be conveyed, which runs helically along the inner peripheral surface from the first side to the second side. The at least one conveying path comprises at least one anchoring element, and the jacket comprises at least one through-opening assigned to the at least one anchoring element. The at least one anchoring element reaches through the at least one through-opening or engages therein and is integrally bonded to an edge of the at least one through-opening, in particular by welding.

In a second aspect of the present disclosure, a method for producing a conveying device, in particular in accordance with the first aspect, is provided. The method comprises:
providing at least one conveying path comprising at least one anchoring element;
providing a jacket or a flat material comprising at least one through-opening;
positioning the at least one anchoring element such that it reaches through the at least one through-opening or engages therein from a first side of the jacket or of the flat material; and—integrally bonding, in particular by welding, the at least one anchoring element to an edge of the at least one through-opening of a second side of the jacket or of the flat material, the second side facing away from the first side.

### BRIEF DESCRIPTION OF THE DRAWINGS

The foregoing summary and the following description may be better understood in conjunction with the drawing figures, of which:

FIG. 1 is a perspective view of the conveying device in accordance with the present disclosure in a preferred embodiment, which comprises a conveying pot;

FIG. 2 is a perspective view of the conveying insert of the conveying device from FIG. 1, which comprises a jacket, conveying paths, and a base wall;

FIG. 3 is a sectional view of the conveying device from FIG. 1;

FIG. 4 is an enlarged view of detail A in FIG. 3;

FIG. 5 is an enlarged view of detail B in FIG. 2;

FIG. 6 is a view similar to FIG. 5, wherein the viewing direction is in the direction of the arrow “6” in FIG. 5;

FIG. 7 is a view relating to the production of the conveying device, wherein the viewing direction is in the direction of the arrow “7” in FIG. 5;

FIG. 8 is a view similar to FIG. 7 at a later point in time during production of the conveying device; and

FIG. 9 is a simplified schematic view of a conveying device in accordance with the present disclosure.

### DETAILED DESCRIPTION

Although the present disclosure is illustrated and described herein with reference to specific embodiments, the present disclosure is not intended to be limited to the details shown. Rather, various modifications may be made in the details within the scope and range of equivalents without departing from the present disclosure.

The present disclosure relates to a conveying device for objects to be conveyed, for example for pharmaceutical packaging material or parts thereof, wherein the conveying device comprises or forms a conveying pot with a base wall or is part of a conveying pot with a base wall, wherein the conveying device comprises a jacket which comprises an inner peripheral surface and an outer peripheral surface and extends from a first side to a second side, and at least one conveying path for the objects to be conveyed, which runs helically along the inner peripheral surface from the first side to the second side, wherein the at least one conveying path comprises at least one anchoring element, and the jacket comprises at least one through-opening assigned to the at least one anchoring element, wherein the at least one anchoring element reaches through the at least one through-opening or engages therein and is integrally bonded to an edge of the at least one through-opening, in particular by welding.

In the conveying device in accordance with the present disclosure, the jacket is provided, the first side of which can be arranged in particular on the base wall and, for example, connected thereto. From the first side to the second side, on which, for example, a free edge of the jacket is formed, at least one conveying path extends helically along the inner peripheral surface. The conveying path can, for example, be referred to as a “conveying helix.” When used as intended, objects to be conveyed can reach onto the conveying path and be conveyed thereon from the first to the second side. The at least one conveying path is connected to the jacket by means of at least one anchoring element which reaches through the through-opening or engages therein. The integral bonding, preferably by welding, allows simple and cost-effective production. The present disclosure takes into account the consideration that the anchoring element can be connected to the edge from the side of the outer peripheral surface of the jacket as a result of the through-opening during production. A corresponding connection position between the anchoring element and the edge is easily accessible. Preferably, this makes it possible to avoid connecting the conveying path to the jacket from the side of the inner peripheral surface, which is more difficult to reach due to the conveying path running there. In addition, the number of connection positions between the conveying path and the jacket can preferably be deliberately kept low, and, yet, a reliable fixation of the conveying path can still be achieved.

It is also possible, for example, to manufacture the at least one conveying path separately from the jacket. This proves to be advantageous, for example, in terms of scaling, since conveying paths and jackets can be produced according to the size of the conveying device to be manufactured. It is also conceivable that conveying devices of different sizes can, for example, have conveying paths of the same size, but jackets of different sizes, and vice versa.

Because, for example, a connection between the at least one conveying path and the jacket on the inner peripheral surface can be dispensed with, a relatively small distance between adjacent conveying paths or portions of a conveying path in the rising direction from the first to the second side can preferably be implemented. At a small distance, the objects to be conveyed can orient themselves in the correct target position on the conveying path, whereas they preferably cannot “stand up” and fall off the conveying path. This makes it possible to increase the conveying capacity of the conveying device compared to a conventional conveying device.

A lack of connection between the at least one conveying path and the jacket on the inner peripheral surface can be advantageous because the material to be conveyed cannot come into contact with any connection points between the conveying path and the jacket, since the connection points are arranged on the outer peripheral surface.

During the manufacture of the conveying device, it can be provided that the jacket be already present as a self-contained body. Alternatively, it can be provided that a flat material with at least one through-opening be present, which is formed into a self-contained jacket. As far as a connection between the at least one conveying path and the jacket has been discussed above, this can in particular refer to both of these possibilities.

The present disclosure is particularly suitable for conveying objects to be conveyed in the form of closing elements for pharmaceutical packaging material, in particular caps or stoppers. However, the present disclosure is not limited to these applications and objects to be conveyed.

In a preferred embodiment of the present disclosure, the at least one anchoring element can reach through the at least one through-opening, e.g., in the radial direction, relative to an axis defined by the conveying device, in particular by the jacket.

The at least one anchoring element is preferably integrally formed with the conveying path. The conveying path together with at least one anchoring element can be manufactured in whole or in part, for example, as a stamped part from a sheet metal material. A material of the jacket can, for example, be a stamped part made of a sheet metal material.

The at least one conveying path and/or the at least one anchoring element are preferably formed from a flat material. The at least one anchoring element can, for example, be arranged in a plane formed by the at least one conveying path.

The jacket can, for example, be formed from a flat material.

Preferably, the conveying device is made entirely or partially of pharmaceutical-grade materials.

It can be provided that the at least one anchoring element be connected to the edge of the at least one through-opening on the outer peripheral surface. In such an embodiment, the anchoring element in particular reaches through the through-opening and may, for example, comprise a connecting portion which can be placed on the outer peripheral surface and subsequently connected thereto. Alternatively, for example, a connecting portion is provided at a distance from the outer peripheral surface, and is connected to the edge.

In a further embodiment of the present disclosure, it can be provided that the at least one anchoring element be connected to the jacket at an edge, running in a material layer of the jacket, of the at least one through-opening. In this embodiment, the connection can be provided in the through-opening itself.

For example, a free space between the at least one anchoring element within the at least one through-opening of at least approximately 1 mm and preferably at least approximately 2 mm may prove advantageous. Such a free space is, for example, during cleaning processes, in particular during rinsing in a parts washer and/or during autoclaving, large enough to reliably remove residues of the cleaning agent, in particular a cleaning fluid, after the cleaning process. For example, remaining cleaning fluid can dry off reliably.

In one embodiment of the present disclosure, it can be provided that a free space between the at least one anchoring element within the at least one through-opening be less than approximately 5 mm, preferably less than approximately 3 mm.

The free space can be an air gap, for example.

The at least one anchoring element preferably reaches through the at least one through-opening with play, or engages therein with play. This advantageously makes it possible to provide a sufficiently large free space between the anchoring element and the edge of the opening.

In a preferred embodiment of the present disclosure, the at least one anchoring element comprises a web portion protruding from the at least one conveying path and at least one connecting portion protruding from the web portion, e.g., laterally, wherein the web portion reaches through the at least one through-opening, and the at least one connecting portion is connected to the edge on the outer peripheral surface. The web portion reaches through the through-opening, and the at least one connecting portion can, in a preferred embodiment, rest on the outer peripheral surface at the edge. By means of integral bonding, in particular welding, the anchoring element can be connected to the edge in this way without additional material.

The at least one connecting portion protrudes laterally from the web portion, for example, in a circumferential direction of the jacket.

The at least one anchoring element may preferably comprise two connecting portions protruding from the web portion in opposite directions, each of which is connected to the edge. In this way, a particularly reliable connection can be achieved.

The at least one anchoring element is formed to be substantially T-shaped or mushroom-shaped in a plan view, for example, in the axial direction of the jacket.

In a preferred embodiment of the present disclosure, the at least one through-opening may comprise a first portion and a second portion which is arranged laterally adjacent to the first portion, wherein the web portion reaches through the second portion, and the at least one connecting portion is connected to the edge laterally adjacent to the first portion and the second portion. During the production of the conveying device, the at least one anchoring element is, for example, guided through the first portion, and then the web portion is positioned in the second portion of the through-opening, so that the at least one connecting portion is positioned on an edge region of the edge laterally adjacent to the first portion and the second portion, and preferably rests on this edge region.

The first portion may, for example, be slot-shaped.

The second portion may, for example, be formed as a bulge of the first portion.

It can be provided that the at least one through-opening be at least partially slot-shaped, in particular with a longitudinal extension in the circumferential direction of the jacket.

The at least one conveying path may preferably comprise two or more anchoring elements, each connected to the jacket. This allows a more reliable connection between the conveying path and the jacket to be achieved. The two or more anchoring elements are advantageously designed identically.

An angular distance between adjacent anchoring elements of the at least one conveying path, relative to an axis of the conveying device, may, for example, be approximately 20° to 50°, preferably approximately 30° to 40°.

It may be advantageous if the conveying device is free of a connection between the at least one conveying path and the jacket on the inner peripheral surface. This eliminates the need to engage between adjacent conveying paths or portions of the same conveying path during the production of the conveying device. This can simplify the production of the conveying device. In particular, it is possible to position adjacent conveying paths or portions of the same conveying path relatively close to one another. For example, the paths or portions of the same path can be positioned so close to one another that the objects to be conveyed can be transported only lying down on the conveying path in the correct target position (possibly in two orientations). The conveying capacity of the conveying device can be increased in this way.

The at least one conveying path is preferably free of contact with the jacket on the inner peripheral surface.

A ratio of a width of the at least one conveying path—this can be referred to as “aisle width,” for example—to a distance between adjacent conveying paths or adjacent portions of a conveying path—this can be referred to as “aisle height,” for example—can, in a preferred embodiment of the present disclosure, be, for example, 1:4 to 1, preferably approximately 1:3 to 3:4, e.g., approximately 1:2. The ratio of approximately 1:3 to 3:4 is used, for example, in a conveying device for closing elements such as crimp caps or stoppers.

For example, the width of the at least one conveying path is dimensioned such that the object to be conveyed is completely positioned thereon in the correct target position and does not protrude beyond the conveying path, whereby the conveying path does not protrude beyond the object to be conveyed, or protrudes only to a small extent. The above ratio is preferably selected such that the objects to be conveyed can be transported in the desired position (possibly in two orientations), but cannot move into an incorrect position (for example, standing or erect).

When conveying closing elements, the aisle width may, for example, be approximately equal to or larger than the diameter of the closing elements, but conveyance may also be possible with an aisle width that is smaller than the diameter, for example, up to approximately 60% of the diameter.

When conveying closing elements, the aisle height may preferably be smaller than the aisle width.

When conveying containers, the aisle height is preferably smaller than the height of the containers in their erect state.

Containers are advantageously conveyed lying down.

The conveying device may, as follows from what has been said, comprise two or more conveying paths, for example, which can run into one another. For example, three conveying paths are provided.

The conveying device may comprise or form a conveying pot which has a base wall, wherein the jacket protrudes from the base wall. The jacket may be free of any connection to the base wall or may be connected to the base wall, for example, by welding.

The conveying device may comprise an insert which comprises the jacket with the at least one conveying path. In particular, the jacket with the at least one conveying path may form the conveying device.

The conveying device may comprise an insert which comprises the jacket with the at least one conveying path. The insert may comprise a base wall. The insert may be referred to, for example, as a “conveying insert” or “sorting insert.”

The conveying device and/or the conveying pot may comprise at least one outer jacket surrounding the jacket in the circumferential direction and connected to the jacket. For example, objects to be conveyed that are released from the second side of the jacket are transported away between the jacket and the outer jacket or between two outer jackets and fed for processing. For example, a transport path for the objects to be conveyed can be arranged in the gap between them. The outer jacket can be connected to the jacket directly or indirectly, for example, via the base wall.

Advantageously, the conveying device comprises a drive device for driving the conveying pot in particular in an oscillating manner. The drive device can, for example, act upon the base wall, the jacket, or the outer jacket and cause them to oscillate.

In a preferred form of the present disclosure, the jacket may, for example, have a cylindrical shape, in particular the shape of a vertical circular cylinder, wherein the at least one conveying path is helical.

A diameter of the jacket can in particular be constant over its entire extent from the first side to the second side.

In a further preferred form of the present disclosure, the jacket can, for example, have a shape that widens, in particular conically, from the first side to the second side, and the at least one conveying path is spiral-shaped.

As mentioned at the outset, the present disclosure also relates to a method for producing a conveying device. An object of the present disclosure is to provide a conveying device which is characterized by simplified production.

This object is achieved by a method in accordance with the present disclosure for producing a conveying device, in particular of the type described above, comprising:
providing at least one conveying path comprising at least one anchoring element;
providing a jacket or a flat material comprising at least one through-opening;
positioning the at least one anchoring element such that it reaches through the at least one through-opening or engages therein from a first side of the jacket or of the flat material;
integrally bonding, in particular by welding, the at least one anchoring element to an edge of the at least one through-opening from a second side of the jacket or of the flat material, which side faces away from the first side.

The first side is in particular the side on which the inner peripheral surface of the jacket is arranged in the intended use. The second side is the side on which the outer peripheral surface is arranged.

The advantages already achieved in connection with the explanation of the conveying device in accordance with the present disclosure can also be achieved by carrying out the method. To avoid repetition, reference is made to the above statements.

Advantageous exemplary embodiments of the method in accordance with the present disclosure follow from advantageous embodiments of the device in accordance with the present disclosure. The advantageous features described with reference to the device can be implemented in a method for its production. To avoid repetition, reference can be made to the above statements.

During the production of the conveying device, it can be provided that the jacket already be manufactured and the at least one conveying path be connected to the existing jacket. Alternatively, it can be provided that a flat material be provided which is connected to the at least one conveying path and is then formed into a jacket.

Advantageously, the at least one anchoring element is connected to the jacket or the flat material without the use of additional material. For example, the anchoring element is applied to the outer peripheral surface at the edge of the through-opening, e.g., via the connecting portion described above, and then connected to the jacket, in particular by welding.

In the case of a connection by welding, a subsequent grinding and/or polishing of the conveying device at the connection points is advantageously carried out.

The at least one conveying path can, before being provided, be formed, for example, from a plurality of segments arranged in a direction of travel of the path, related to the intended use, each of which comprises at least one anchoring element. For example, a plurality of segments are provided which are integrally bonded, in particular by welding. A subsequent grinding and/or polishing process may be required. The conveying path provided from the plurality of segments can then be connected to the jacket or the flat material.

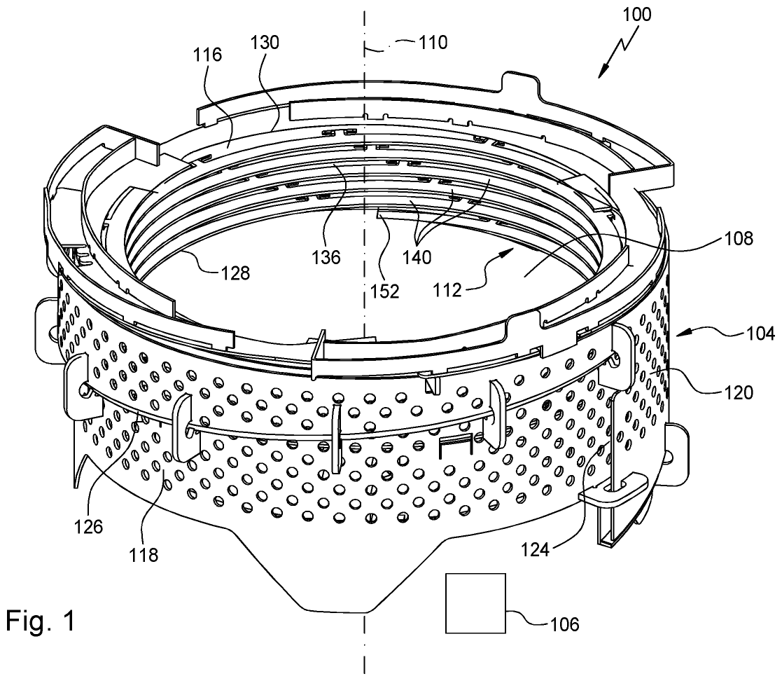

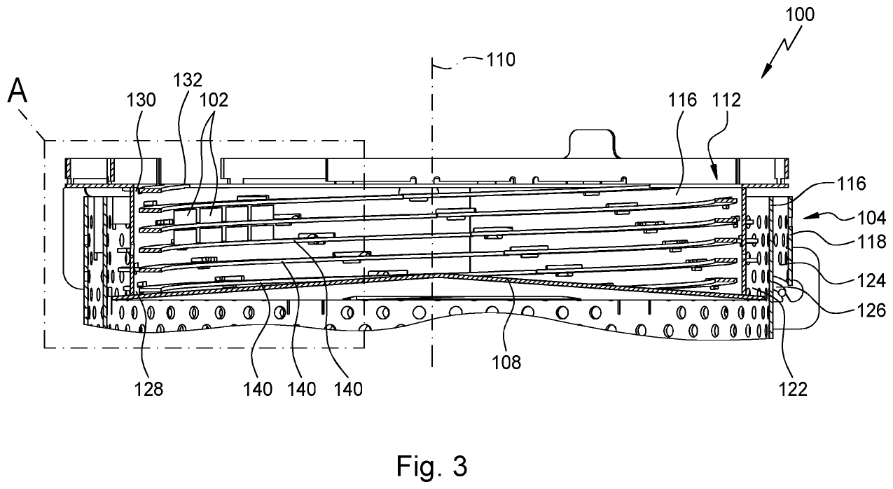

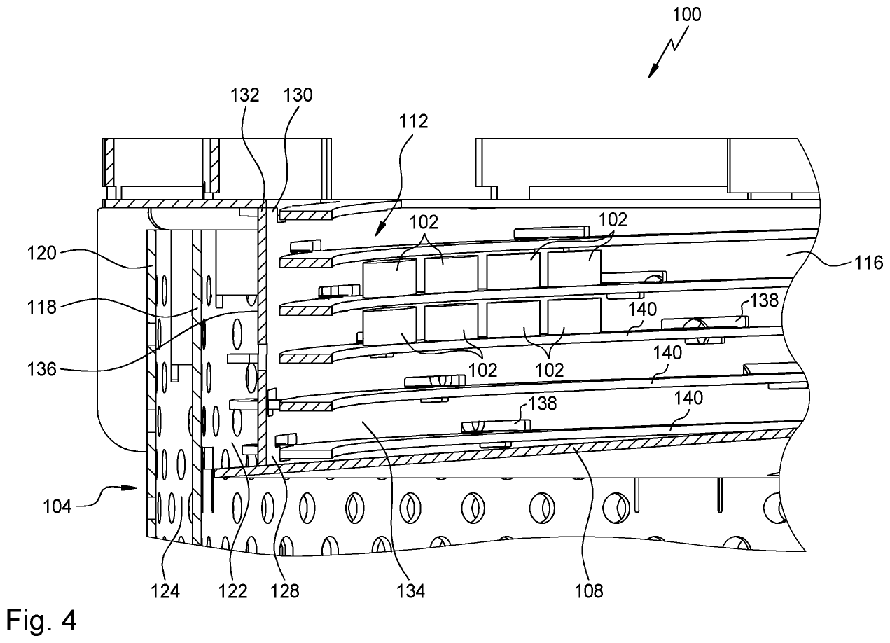

FIG. 1 shows an advantageous embodiment of a conveying device in accordance with the present disclosure for objects to be conveyed 102, shown schematically in FIGS. 3 and 4 and designated overall by the reference numeral 100. In the present embodiment, the objects to be conveyed 102 are closing elements for pharmaceutical containers, in particular crimp caps for vials.

The conveying device 100 comprises a conveying pot 104, which can also be referred to as a “sorting pot.” In order to set the conveying pot 104 in motion and in particular in oscillation, the conveying device 100 preferably comprises a drive device 106, which is shown schematically in FIG. 1.

The conveying pot 104 has a base wall 108 which is formed sloping radially outwards from a center relative to an axis 110 of the conveying device 100 (FIG. 3). Objects to be conveyed 102 are positioned on the base wall 108, e.g., from bags, and are moved radially outwards along the conveying device 100 by the oscillation of the conveying pot 104.

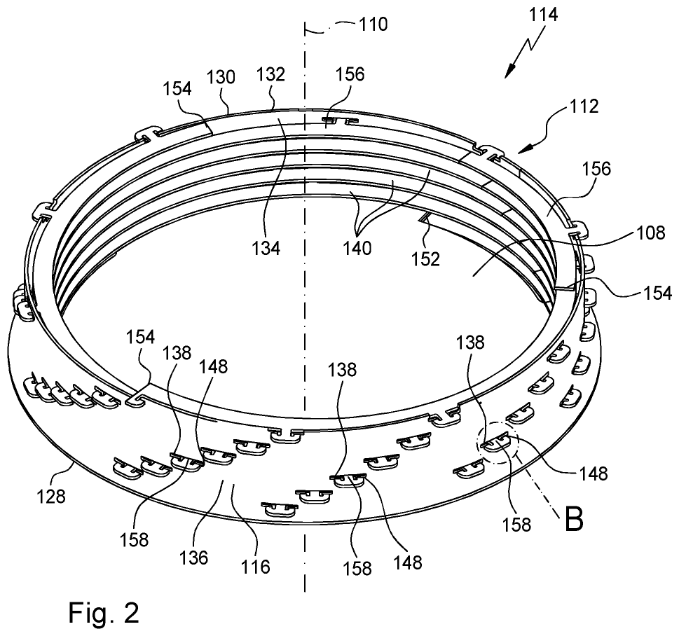

The conveying insert 112, which can be seen in particular in FIG. 2, can in turn form an advantageous embodiment of the conveying device in accordance with the present disclosure, designated by the reference numeral 114. In the present case, this can be understood in particular to mean that the conveying device 114 can consist of the conveying insert 112. A drive device is not absolutely necessary.

In the present example, the conveying insert 112 comprises the base wall 108 and a self-contained jacket 116 which is placed on the base wall 108. The jacket 116 is preferably firmly bonded to the base wall, for example, by welding. The jacket 116 defines an axis that coincides with the axis 110, so that the axis 110 is also an axis of the jacket 116 and of the conveying insert 112.

Orientation specifications such as “axial” and “radial” refer to the axis 110.

The jacket 116 has a cylindrical shape in the present case, in particular the shape of a vertical circular cylinder with the axis 110.

Radially outside the jacket 116, the conveying pot 104 comprises, for example, at least one outer jacket and, in the present case, two outer jackets 118, 120. The outer jacket 118 surrounds the jacket 116, preferably along the entire circumferential direction. The outer jacket 120 surrounds the outer jacket 118 at least in sections along the circumferential direction.

The outer jackets are connected to one another. The conveying insert 112 is connected to the outer jacket 118, for example, at the base wall 108 (FIG. 3), for example, by welding.

A gap 122 is formed between the jacket 116 and the outer jacket 118. A further gap 124 is formed between the outer jackets 118, 120.

A transport path 126, designed as a roller path, extends from an upper side, facing away from the base wall 108, of the conveying device 100 in the gap 124 downwards and ends, for example, approximately in the region of the base wall 108. Objects to be conveyed 102, which are conveyed upwards via the conveying insert 112 as explained below, can reach the transport path 126 and are fed for processing.

The drive device 106 acts, for example, upon at least one outer jacket 118 and/or 120 and, via this, upon the jacket 116 and/or the base wall 108. Alternatively or additionally, for example, the base wall 108 can be excited to oscillate by the or a drive device 106.

As can further be seen from the drawing, the jacket 116 is closed in the circumferential direction of the axis 110 and extends from a first side 128 in the axial direction to a second side 130. The first side 128 faces the base wall 108. The second side 130 faces away from the base wall 108 and is formed by a free edge 132 of the jacket 116.

The jacket 116 comprises an inner peripheral surface 134 radially inside and an outer peripheral surface 136 radially outside.

In the present case, the jacket 116 is made of a flat material, e.g., sheet metal, which has been shaped and self-contained in particular by welding.

The conveying device 100 is used in particular in a plant for processing pharmaceutical packaging materials, in particular containers. It is therefore advantageous if all materials of the conveying device 100 are designed in compliance with pharmaceutical standards. For example, the conveying pot 104 and the conveying insert 112 are made from pharmaceutical-grade stainless steel.

At least one through-opening 138 is formed in the jacket 116. In the present case, a plurality of through-openings 138 are provided, which can in particular be designed identically.

As can be seen in particular from FIG. 2, the through-openings 138 are arranged helically on the jacket 116. Successive through-openings 138 associated with a respective conveying path 140 have an angular distance with respect to the axis 110 of approximately 30° to 40°.

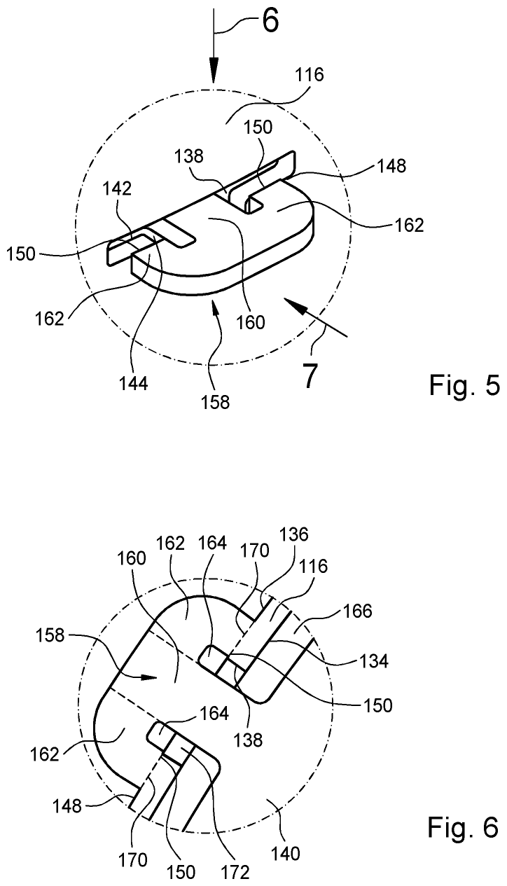

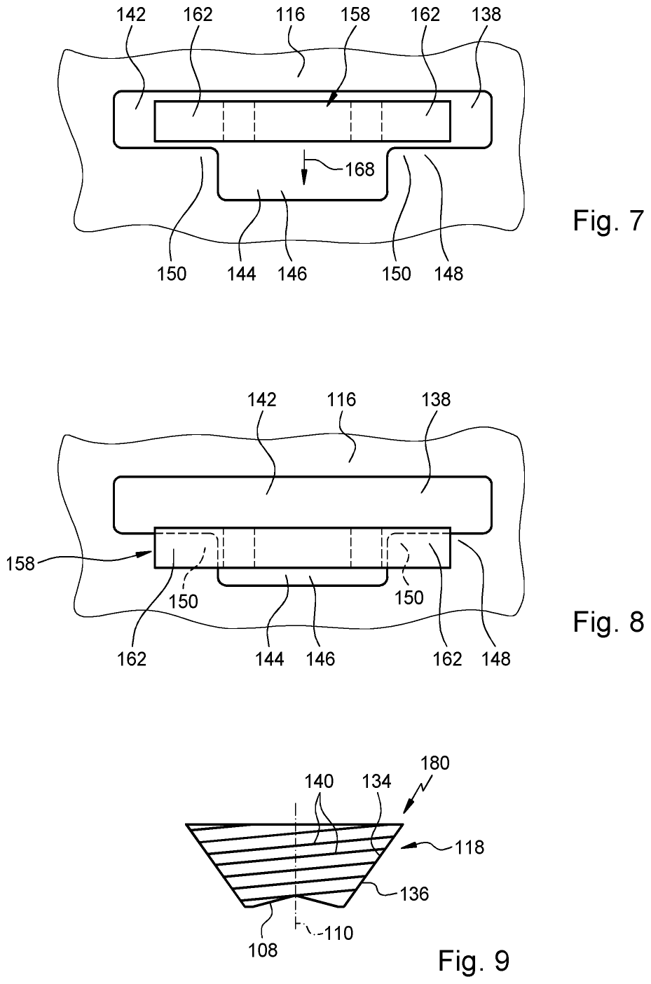

As can be seen in particular from FIGS. 5 to 8, a respective through-opening 138 is at least partially slot-shaped with a longitudinal extension in the circumferential direction of the jacket 116. The through-opening comprises a first portion 142, which is slot-shaped, and a second portion 144. The second portion 144 can be viewed, for example (FIG. 7), as a bulge 146 on the first portion 142.

The shape of the through-opening 138 in plan view in the radial direction can be approximately described, for example, by a T that is greatly stretched along the circumferential direction, wherein the slot-shaped first portion 142 represents the cross of the T.

The portion 144 is arranged centrally in the circumferential direction with respect to the portion 142. The through-opening 138 is designed symmetrically overall.

The through-opening 138 has an edge 148 which encloses the free opening of the through-opening 138 and surrounds both portions 142, 144. Edge regions 150 are arranged laterally adjacent to the first portion 142 and the second portion 144, wherein the edge regions 150 are opposite one another with respect to the portion 144.

The conveying path 140 already mentioned serves to convey objects 102 from the first side 128 to the second side 130 under excitation by the drive device 106.

The conveying insert 112 comprises at least one conveying path 140. In the present case, three conveying paths 140 are provided, which run into one another and are in particular designed identically, such that only one conveying path 140 will be discussed below. The explanations in this regard also apply to the other conveying paths 140.

The conveying paths 140 run helically along the inner peripheral surface 134 from the first side 128 to the second side 130. In the present case, the conveying paths 140 are helical.

Starting from the base wall 108, the conveying paths 140 are positioned such that their beginnings 152 have an angular distance of 1200 with respect to the axis 110. The same applies to the respective ends 154 of the conveying paths 140 (FIG. 2).

The respective conveying path 140 is made, for example, of a flat material, in particular sheet metal. The conveying path 140 can, for example, be formed from a plurality of segments 156 joined together in the direction of travel. The segments 156 are preferably integrally bonded, for example, by welding.

One-third of the through-openings 138 are assigned to each conveying path 140.

The conveying path 140 comprises at least one anchoring element 158, preferably a plurality of anchoring elements 158. In particular, one anchoring element 158 is assigned to each through-opening 138.

The anchoring element 158 is formed integrally with the conveying path 140 and is arranged, for example, within the plane defined by the conveying path 140. The anchoring element 158 can be formed from a flat material.

The anchoring element 158 is provided for connecting the conveying path 140 to the jacket 116. As can be seen in particular from FIGS. 1, 5, and 6, the anchoring element 158 protrudes from the conveying path 140 in the radial direction. The anchoring element 158 reaches through the through-opening 138 and is connected to the edge 148 on the outer peripheral surface 136 in the operating state of the conveying device 100.

In this case, integral bonding by welding is provided.

Welded joints in the conveying device 100 preferably undergo grinding and/or polishing before completion.

The anchoring element 158 has, as can be seen in particular from FIGS. 5 and 6, a web portion 160. The web portion is fixed radially inside, with respect to the jacket 116, on the rest of the conveying path 140. The web portion 160 reaches through the through-opening 138. At least one connecting portion 162 protrudes laterally from the web portion 160 radially outside—in the present example, along the circumferential direction.

In the present case, two connecting portions 162 are provided, which protrude from the web portion 160 in directions facing away from one another. The anchoring element 158 is therefore approximately T-shaped or mushroom-shaped in plan view in the axial direction. A gap 164 can be provided between the web portion 160 and a region, contacting the edge 148, of the respective connecting portion 162.

The anchoring element 158 and the through-opening 138 are dimensioned such that, when the conveying insert 112 is in use, there is a free space between the anchoring element 158 and the edge 148. The free space is preferably at least 1 mm, more preferably at least approximately 2 mm. For example, the free space may be less than approximately 5 mm, preferably less than approximately 3 mm.

The provision of a free space improves the cleaning properties of the conveying device. During cleaning with fluids, any residues of the cleaning fluid can be dried and/or drained off, and do not adhere to the conveying insert 112.

The conveying path 140 extends radially inwards with respect to the jacket 116, wherein a gap 166 is present between the jacket 116 and the conveying path 140 (FIG. 6). The conveying path 140 is thus free of contact with the jacket 116 on the inner peripheral surface 134. Cleaning fluid present in the region of the gap 166 can also be dried and/or drained off, which improves the cleaning properties of the conveying insert 112.

In the present embodiment, the conveying path 140 is free of any connection to the jacket 116 along the inner peripheral surface 134. In a technically simple manner, the connection to the jacket 116 can be made from the outside on the outer peripheral surface 136, as has already been explained.

Avoiding the connection radially inside facilitates the production of the conveying insert 112. In addition, it is possible for conveying paths 140 adjacent to one another in the axial direction to be at a relatively small distance from one another.

In the present example, a ratio of the width of the conveying path 140 (“aisle width”) to a distance between adjacent conveying paths 140 (“aisle height”) is approximately 1:2. The aisle width is preferably selected such that it is approximately as large as the diameter of the objects to be conveyed 102 configured as closing elements.

In the present case, the distance is selected such that the objects to be conveyed 102 can be conveyed only lying down in a correct target position on the conveying path 140 (although the objects to be conveyed 102 can assume two orientations). In contrast, the objects to be conveyed 102 cannot reach the conveying path 140 in a standing position or stand upright, because the gap between adjacent conveying paths 140 is not sufficient for this.

In practice, it has been shown that in this way a high conveying capacity can be achieved with the conveying device 100, since the objects to be conveyed 102, once they have reached the conveying path 140, can, with a high degree of probability, be conveyed to the second side 130, and the proportion of the objects to be conveyed 102 that fall back into the conveying pot 104 is relatively small.

During the production of the conveying device 100, in particular the conveying insert 112, the procedure can, for example, be as follows.

First, the at least one conveying path 140 with the at least one anchoring element 158 and the jacket 116 with at least one through-opening 138 are provided. Instead of a self-contained jacket 116, as explained above, a flat material, for example, can be provided which is not yet self-contained, wherein the connection to the jacket 116 is carried out only subsequently.

Beforehand, for example, the conveying path 140 can be formed from the plurality of segments 156.

To connect the conveying path 140 to the jacket 116 or the flat material, the anchoring element 158 is guided from a first side, on which the inner peripheral surface 134 is located, through the first portion 142 of the through-opening 138 (FIG. 7). The through-opening 138 is dimensioned relative to the anchoring element 158 such that said anchoring element can be guided through with play.

The anchoring element 158 is then moved in the axial direction such that the web portion 160 engages in the second portion 144 (arrow 168). The connecting portions 162 are thereby positioned at the edge regions 150 (FIG. 8). From the second side, on which the outer peripheral surface 136 is located, the anchoring element 158 can be connected to the jacket 116. The integral bonding, in particular by welding, can be carried out, without additional material, between the connecting portions 162 and the edge 148. The integral bonding is indicated in FIG. 6 by a dashed line 170.

The gap 164 is preferably aligned with the free space 172 of the second portion 144 between the edge region 150 and the web portion 160, whereby any cleaning fluid between the web portion 160 and the connecting portions 162 can be removed or dried in an improved manner during cleaning.

The conveying device 100 has been described above using the example of objects to be conveyed 102, which are closing elements of pharmaceutical containers.

The intended use of the conveying device in accordance with the present disclosure is not limited to the conveyance of such objects to be conveyed 102. It is also conceivable to use it with a different type of material to be conveyed, for example, containers made of different materials. For example, plastic containers, especially plastic bottles, are conceivable.

FIG. 9 schematically shows an advantageous embodiment of the conveying device in accordance with the present disclosure, designated by the reference numeral 180. Identical reference signs are used for identical or similarly acting features and components of the conveying devices 100 and 180.

The jacket 116 of the conveying device 180 has a shape that widens from the first side 128 to the second side 130—in this case, conical and in particular in the shape of a truncated cone. The at least one conveying path 140 is spiral-shaped. Furthermore, reference is made to the above statements regarding features of the conveying device 100 which can also be provided in the conveying device 180.

### LIST OF REFERENCE NUMERALS

100 Conveying device
102 Object to be conveyed
104 Conveying pot
106 Drive device
108 Base wall
110 Axis
112 Conveying insert
114 Conveying device
116 Jacket
118 Outer jacket
120 Outer jacket
122 Gap
124 Gap
126 Transport path
128 First side
130 Second side
132 Free edge
134 Inner peripheral surface
136 Outer peripheral surface
138 Through-opening
140 Conveying path
142 First portion
144 Second portion
146 Bulge
148 Edge
150 Edge region
152 Start
154 End
156 Segment
158 Anchoring element
160 Web portion
162 Connecting portion
164 Gap
166 Gap
168 Arrow
170 Dashed line
172 Free space
180 Conveying device

1. A conveying device for objects to be conveyed, the objects being pharmaceutical packaging material or parts thereof, wherein the conveying device comprises or forms a conveying pot with a base wall or is part of a conveying pot with a base wall, the conveying device further comprising:
a jacket which comprises an inner peripheral surface and an outer peripheral surface and extends from a first side to a second side; and
at least one conveying path for the objects to be conveyed, the at least one conveying path running helically along the inner peripheral surface from the first side to the second side,
the at least one conveying path comprising at least one anchoring element,
the jacket comprising at least one through-opening assigned to the at least one anchoring element, and
the at least one anchoring element reaching through the at least one through-opening or engaging in the at least one through-opening and being integrally bonded by welding to an edge of the at least one through-opening.

2. The conveying device according to claim 1, wherein the at least one anchoring element is integrally bonded to the edge of the at least one through-opening by welding.

3. The conveying device according to claim 1, wherein the at least one anchoring element reaches through the at least one through-opening in a radial direction, relative to an axis defined by the conveying device.

4. The conveying device according to claim 1, wherein the at least one anchoring element is integrally formed with the at least one conveying path.

5. The conveying device according to claim 1, wherein the at least one anchoring element is connected to the edge of the at least one through-opening on the outer peripheral surface.

6. The conveying device according to claim 1, wherein the at least one anchoring element is connected to the jacket at an edge, running in a material layer of the jacket, of the at least one through-opening.

7. The conveying device according to claim 1, further comprising at least one of:
a free space between the at least one anchoring element within the at least one through-opening of at least approximately 1 mm; and
a free space between the at least one anchoring element within the at least one through-opening of less than approximately 5 mm.

8. The conveying device according to claim 1, wherein the at least one anchoring element reaches through the at least one through-opening with play or engages in the at least one through-opening with play.

9. The conveying device according to claim 1, wherein the at least one anchoring element comprises a web portion protruding from the at least one conveying path and at least one connecting portion protruding from the web portion, wherein the web portion reaches through the at least one through-opening, and the at least one connecting portion is connected to the edge on the outer peripheral surface.

10. The conveying device according to claim 9, wherein the at least one anchoring element comprises two connecting portions protruding from the web portion in opposite directions, each of the two connecting portions connected to the edge.

11. The conveying device according to claim 9, wherein the at least one anchoring element is formed to be substantially T-shaped or mushroom-shaped in a plan view.

12. The conveying device according to claim 9, wherein the at least one through-opening comprises a first portion and a second portion which is arranged laterally adjacent to the first portion, wherein the web portion reaches through the second portion, and the at least one connecting portion is connected to the edge laterally adjacent to the first portion and the second portion.

13. The conveying device according to claim 12, wherein the first portion is slot-shaped and/or wherein the second portion is formed as a bulge of the first portion.

14. The conveying device according to claim 1, wherein the at least one through-opening is at least partially slot-shaped and/or has a longitudinal extension in a circumferential direction of the jacket.

15. The conveying device according to claim 1, wherein the at least one conveying path comprises two or more anchoring elements each connected to the jacket.

16. The conveying device according to claim 15, wherein an angular distance between adjacent anchoring elements of the at least one conveying path relative to an axis of the conveying device is approximately 200 to 50°.

17. The conveying device according to claim 1, wherein at least one of the following applies:
the conveying device is free of a connection between the at least one conveying path and the jacket on the inner peripheral surface; and
the at least one conveying path is free of contact with the jacket on the inner peripheral surface.

18. The conveying device according to claim 1, wherein a ratio of a width of the at least one conveying path to a distance between adjacent conveying paths or adjacent portions of a conveying path is approximately 1:4 to 1:1.

19. The conveying device according to claim 1, wherein the conveying device comprises two or more conveying paths, which run into one another.

20. The conveying device according to claim 1, wherein the conveying device comprises or forms a conveying pot which has a base wall, wherein the jacket protrudes from the base wall.

21. The conveying device according to claim 1, wherein the conveying device has an insert which comprises the jacket with the at least one conveying path, and at least one outer jacket which surrounds the jacket in a circumferential direction and is connected to the jacket.

22. The conveying device according to claim 1, wherein the conveying device comprises a drive device for oscillating driving.

23. The conveying device according to claim 1, wherein:
the jacket has a cylindrical shape and the at least one conveying path is helical; or
the jacket has a shape which widens conically from the first side to the second side, and the at least one conveying path is spiral-shaped.

24. A method for producing a conveying device, the method comprising the steps of:
providing at least one conveying path comprising at least one anchoring element;
providing a jacket or a flat material comprising at least one through-opening;
positioning the at least one anchoring element to reach through the at least one through-opening or to engage in the at least one through-opening from a first side of the jacket or of the flat material; and
integrally bonding the at least one anchoring element to an edge of the at least one through-opening of a second side of the jacket or of the flat material, the second side facing away from the first side.

25. The method according to claim 24, wherein the at least one anchoring element is integrally bonded to the edge of the at least one through-opening by welding.

26. The method according to claim 24, wherein the at least one anchoring element is connected to the jacket or the flat material without using additional material.

27. The method according to claim 24, wherein the at least one conveying path is formed, before the step of being provided, from a plurality of segments arranged in a direction of travel of the path, each of the plurality of segments comprising at least one anchoring element.
